(19) United States
(12) Patent Application Publication
(10) Pub. No.: US 2019/0031850 A1
(43) Pub. Date: Jan. 31, 2019

(54) REFLECTIVE ARTICLES COMPRISING A MICRO-CELLULAR STRUCTURE AND CHARACTERIZED BY IMPROVED (BLUE) LED AGING PERFORMANCE

(71) Applicant: SABIC Global Technologies B.V., Bergen op Zoom (NL)

(72) Inventors: Franciscus Petrus Maria MERCX, Halsteren (NL); Andries Jakobus Petrus VAN ZYL, Bergen op Zoom (NL); Hendrikus Petrus Cornelis VAN HEERBEEK, Bergen op Zoom (NL); Sascha Jan TER HORST, Dordrecht (NL)

(21) Appl. No.: 15/566,750

(22) PCT Filed: Apr. 4, 2016
(86) PCT No.: PCT/IB2016/051908

§ 371 Date: Feb. 15, 2018

Related U.S. Application Data
(60) Provisional application No. 62/148,409, filed on Apr. 16, 2015.

(51) Int. Cl. C08J 9/00; C08J 9/228; C09K 11/02; C09K 11/88; C09K 11/55; C09K 11/77; C09K 11/59; C09K 11/08; C09K 11/56; C09K 11/64; C09K 11/06; C09K 11/69; F21V 7/22

(52) U.S. Cl. CPC C08J 9/0061; F21V 9/16; C08J 9/228; C09K 11/02; C09K 11/883; C09K 11/55; C09K 11/7706; C09K 11/7728; C09K 11/592; C09K 11/0883; C09K 11/562; C09K 11/643; C09K 11/06; C09K 11/691; F21V 7/22; C08J 2205/052; C08J 2205/044; C08J 2369/00; C08J 2483/10; C09K 2211/1018; C08J 9/0066

(57) ABSTRACT

Provided are articles having a cellular structure and also having improved aging performance under certain types of illumination. Also provided are methods of utilizing the disclosed articles.

### RELATED APPLICATION

The present application claims priority to and the benefit of U.S. patent application Ser. No. 62/148,409, “Reflective Articles Comprising a Micro-Cellular Structure and Characterized by Improved (Blue) LED Aging Performance” (filed Apr. 16, 2015), the entirety of which application is incorporated herein by reference for any and all purposes.

### TECHNICAL FIELD

The present disclosure relates to the field of reflective cellular materials.

### BACKGROUND

Because of their efficiency and because of emerging legislation, LED lights are replacing incandescent and halogen light sources. Some LED light sources have been optimized with respect to lumen/watt output to render them as energy efficient as possible. This may be accomplished, e.g., by using a blue-emitting LED exiting green/yellow phosphors to emit “white” light.

Initially, development focused on the lifetime and light output of the LED itself. Over time, it was realized that the materials used in the primary and secondary optics could age as well. Aging and discoloration of the primary optics not only leads to reduced transmission that is acute in the blue and blue-green regions it also results in a decrease in Correlated Color Temperature (CCT), which can result in an unacceptable color change over time.

Diffuse reflectors are at times combined with LED lights to get a homogenous illumination, particularly for indirect light, or to get a higher efficacy by combining them in the reflector of a spot light. Some have developed materials that have a high reflectivity for reflecting visible light. Most of these materials are based on PC or polyesters and are highly loaded with titanium dioxide or other whitening agents. These materials, however, when exposed to high intensity white LEDs are prone to aging. Although the exact again mechanism is not yet known, photo-thermal thermal degradation can result in yellowing. After yellowing occurs, the absorption of particular the blue and blue-green light increases, speeding up the degradation (auto-catalytic effect) and leading to catastrophic failure.

Without being bound to any particular theory, aging may be the result of exposure of the material to high-intensity blue and long wavelength UV phonons emitted by the LED/phosphor matrix. At the present time, incandescent or LED lamps in combination with either aluminum or anodized metal (specular) reflectors directing the light towards white plastered/painted walls/ceilings are used or ceramic-coated white reflectors are used in illumination applications. In addition, the use of white diffuse reflecting polymers is growing. Accordingly, there is a need in the art for reflective articles having improved aging performance under blue LED illumination.

### SUMMARY

In meeting these long-felt needs, the present disclosure first provides articles, comprising: a region having a cellular structure comprising a plurality of cells, the plurality of cells having a number-average cross-sectional dimension in the range of from about 0.3 micrometers up to about 100 micrometers, and the article having a YI of less than 15 upon exposure for 100 hours to 35 kW/m².

The present disclosure also provides methods of modifying illumination performance, comprising in an illumination device having a surface configured to reflect illumination, replacing or covering at least some of said surface with an article according to the present disclosure.

### BRIEF DESCRIPTION OF THE DRAWING

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawing:

FIG. 1 provides the Spectrum of the blue-LEDs used in the ETIC-082 equipment for accelerated testing of exemplary articles.

### DETAILED DESCRIPTION OF ILLUSTRATIVE EMBODIMENTS

The present invention can be understood more readily by reference to the following detailed description taken in connection with the accompanying FIGs. and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, can also be provided in combination in a single embodiment. Conversely, various features of the invention that are, for brevity, described in the context of a single embodiment, can also be provided separately or in any subcombination. Further, reference to values stated in ranges includes each and every value within that range. Any documents cited herein are incorporated herein by reference in their entireties for any and all purposes.

Terms

It is also to be understood that the terminology used herein is for the purpose of describing particular aspects only and is not intended to be limiting. As used in the specification and in the claims, the term “comprising” may include the embodiments “consisting of” and “consisting essentially of ” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a virgin polycarbonate” includes mixtures of two or more virgin polycarbonates. Furthermore, for example, reference to a filler includes mixtures of fillers.

Ranges can be expressed herein as from one particular value, and/or to another particular value. When such a range is expressed, another aspect includes from the one particular value and/or to the other particular value. For example, a range of “1 to 10” includes all intermediate values, e.g., 3, 5.56, and 7.3. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated +/− 10% a variation unless otherwise indicated or inferred. For example, “about 10” encompasses the range from 9 to 11, including 10. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

As used herein, the term “effective amount” refers to an amount that is sufficient to achieve the desired modification of a physical property of the composition or material. For example, an “effective amount” of a recycled polycarbonate blend refers to an amount that is sufficient to achieve the desired improvement in the property modulated by the formulation component, e.g. splaying, under applicable test conditions and without adversely affecting other specified properties. The specific level in terms of wt % in a composition required as an effective amount will depend upon a variety of factors including the amount and type of recycled polycarbonate blend, amount and type of virgin polycarbonate polymer compositions, amount and type of impact modifier compositions, including virgin and recycled impact modifiers, and end use of the article made using the composition.

Disclosed are the components useful in preparing the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary.

For example, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (“wt %”) of a component, unless specifically stated to the contrary, is based on the total weight of the formulation or composition in which the component is included. For example if a particular element or component in a composition or article is said to have 8% by weight, it is understood that this percentage is relative to a total compositional percentage of 100% by weight.

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this invention belongs.

The term “alkyl group” as used herein is a branched or unbranched saturated hydrocarbon group of 1 to 24 carbon atoms, such as methyl, ethyl, n propyl, isopropyl, n butyl, isobutyl, t butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “aralkyl” as used herein is an aryl group having an alkyl, alkynyl, or alkenyl group as defined above attached to the aromatic group. An example of an aralkyl group is a benzyl group.

The term “thermoplastic” as used herein is a plastic material—suitably a polymer—that becomes pliable or moldable above a specific temperature and solidifies upon cooling.

The term “carbonate group” as used herein is represented by the formula OC(O)OR, where R can be hydrogen, an alkyl, alkenyl, alkynyl, aryl, aralkyl, cycloalkyl, halogenated alkyl, or heterocycloalkyl group described above.

The term “organic residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15, carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15, carbon atoms, 2 to 12 carbon atoms, 2 to 8 carbon atoms, 2 to 4 carbon atoms, or 2 to 4 carbon atoms.

Acrylonitrile-butadiene-styrene (ABS) polymers are derived from acrylonitrile, butadiene, and styrene monomers. ABS materials generally exhibit excellent impact resistance and toughness. In particular, ABS materials combine the strength and rigidity of the acrylonitrile and styrene polymers with the toughness of the polybutadiene rubber. However, when compared to blends of polycarbonate and ABS, neat acrylonitrile-butadiene-styrene is typically used for applications with less stringent mechanical properties, such as tensile, flexural, heat, and fatigue requirements.

Styrene acrylonitrile resin (SAN) is a copolymer plastic comprising styrene and acrylonitrile. The chains of the polymer comprise alternating repeat units of styrene and acrylonitrile.

Polycarbonates (PC) are synthetic thermoplastic resins derived from bisphenols and phosgenes, or their derivatives. They are linear polyesters of carbonic acid and can be formed from dihydroxy compounds and carbonate diesters, or by ester interchange. Polymerization may be in aqueous, interfacial, or in nonaqueous solution. Polycarbonates are a useful class of polymers known for optical clarity and enhanced impact strength, high heat resistance, and relative ductility at room temperature or below. Polycarbonate may refer to an oligomer or polymer comprising residues of one or more dihydroxy compounds, e.g. dihydroxy aromatic compounds, joined by carbonate linkages; it also encompasses homopolycarbonates, copolycarbonates, and (co)polyester carbonates.

As used herein, the terms “PC-PS,” “polycarbonate-siloxane copolymer,” “poly(carbonate-siloxane) copolymer,” and “polycarbonate-polysiloxane copolymer,” which can be used interchangeably, refer to a copolymer comprising repeating carbonate and siloxane units. The terms are inclusive of block copolymers having polysiloxane and polycarbonate blocks.

As used herein, the terms “ABS” and “acrylonitrile-butadiene-styrene copolymer,” which can be used interchangeably, refer to an acrylonitrile-butadiene-styrene polymer which can be an acrylonitrile-butadiene-styrene terpolymer or a blend of styrene-butadiene rubber and styrene-acrylonitrile copolymer.

As used herein, the term “impact modifier” refers to a component of the disclosed impact modified polycarbonate blend compositions wherein the impact modifier is a polymeric material effective in improving the impact properties of the disclosed impact modified polycarbonate blend compositions, e.g. the notched Izod impact strength of the composition. As used herein, an impact modifier can be a one or more polymers such as acrylonitrile butadiene styrene copolymer (ABS), methacrylate butadiene styrene copolymer (MBS), bulk polymerized ABS (BABS), and/or silicon-graft copolymers.

The term “PET” refers to poly(ethylene terephthalate). As used herein the terms “poly(ethylene terephthalate)” and “PET” include PET homopolymers PET copolymers and PETG. As used herein the term PET copolymer refers to PET that has been modified by up to 10 mole percent with one or more added comonomers. For example the term PET copolymer includes PET modified with up to 10 mole percent isophthalic acid on a 100 mole percent carboxylic acid basis. In another example the term PET copolymer includes PET modified with up to 10 mole percent 1,4 cyclohexane dimethanol (CHDM) on a 100 mole percent diol basis. As used herein the term PETG refers to PET modified with 10 to 50 percent CHDM on a 100 mole percent diol basis.

As used herein, the terms “ITR-PC,” and (isophthalic acid-terephthalic acid-resorcinol)-bisphenol A copolyestercarbonate refer to copolyestercarbonates comprising a polycarbonate unit and a polyester unit, the polyester unit derived from the reaction of isophthalic acid, terephthalic acid, and a resorcinol moiety.

The term “talc” is used herein to mean a mineral composed of hydrated magnesium silicate. The term “surface treated talc” (or “surface modified talc” or “coated talc”) is used herein to mean particles of talc, whose surface has been fully or partially, physically or chemically, modified using a surface treating agent. Such agents can be of organic or inorganic nature. These agents can include fatty acids, fatty acid esters, silicones, Teflon, silanes, silane coupling agents, metal salts of fatty acid, or polyethylene glycol.

As used herein the terms “weight percent,” “wt %,” “wt %,” and “wt. %,” which can be used interchangeably, indicate the percent by weight of a given component based on the total weight of the composition, unless otherwise specified. That is, unless otherwise specified, all weight percent values are based on the total weight of the composition. It should be understood that the sum of weight percent values for all components in a disclosed composition or formulation are equal to 100.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Polycarbonates

As described herein, the disclosed articles may comprise a polycarbonate. Polycarbonates are known in the art, and are described in, e.g., PCT/US2013/035456, PCT/US2013/076798, WO2013067684, U.S. Pat. No. 8,426,532, and other sources. Polycarbonates include aromatic carbonate chain units include compositions having structural units of the formula (II):

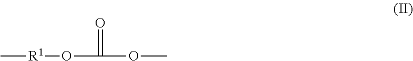

in which the R¹ groups are aromatic, aliphatic or alicyclic radicals. Preferably, R¹ is an aromatic organic radical and, more preferably, a radical of the formula (III):

A1-Y1-A2- (III)

wherein each of A1 and A2 is a monocyclic divalent aryl radical and Y1 is a bridging radical having zero, one, or two atoms which separate A1 from A2. In an exemplary embodiment, one or more atoms separate A1 from A2.

Polycarbonates can be produced by the Schotten-Bauman interfacial reaction of the carbonate precursor with dihydroxy compounds. Polycarbonates can be produced by the interfacial reaction polymer precursors such as dihydroxy compounds.

Typical carbonate precursors include the carbonyl halides, for example carbonyl chloride (phosgene), and carbonyl bromide; the bis-haloformates, for example, the bis-haloformates of dihydric phenols such as bisphenol A, hydroquinone, or the like, and the bis-haloformates of glycols such as ethylene glycol and neopentyl glycol; and the diaryl carbonates, such as diphenyl carbonate, di(tolyl)carbonate, and di(naphthyl)carbonate. The preferred carbonate precursor for the interfacial reaction is carbonyl chloride.

It is also possible to employ polycarbonates resulting from the polymerization of two or more different dihydric phenols or a copolymer of a dihydric phenol with a glycol or with a hydroxy- or acid-terminated polyester or with a dibasic acid or with a hydroxy acid or with an aliphatic diacid in the event a carbonate copolymer rather than a homopolymer is desired for use. Generally, useful aliphatic diacids have about 2 to about 40 carbons. A preferred aliphatic diacid is dodecanedioic acid.

Branched polycarbonates, as well as blends of linear polycarbonate and a branched polycarbonate can also be used. The branched polycarbonates can be prepared by adding a branching agent during polymerization. Polycarbonate can be produced by a melt polycondensation reaction between a dihydroxy compound and a carbonic acid diester. Preferably, the number average molecular weight of the polycarbonate is about 3,000 to about 1,000,000 grams/mole (g/mole). Within this range, it is desirable to have a number average molecular weight of greater than or equal to about 10,000, preferably greater than or equal to about 20,000, and more preferably greater than or equal to about 25,000 g/mole. Also desirable is a number average molecular weight of less than or equal to about 100,000, preferably less than or equal to about 75,000, more preferably less than or equal to about 50,000, and most preferably less than or equal to about 35, 000 g/mole.

Polycarbonate-Polysiloxane Block Copolymers

The disclosed thermoplastic compositions may comprise a polycarbonate-polysiloxane block copolymer component. As used herein, the term polycarbonate-polysiloxane copolymer is equivalent to polysiloxane-polycarbonate copolymer, polycarbonate-polysiloxane polymer, or polysiloxane-polycarbonate polymer.

A non-limiting example of a polycarbonate-siloxane copolymer includes transparent EXL, available from SABIC Innovative Plastics. The transparent EXL from SABIC is a polycarbonate-polysiloxane (9030T) copolymer, having been tested commercially and found to have about 6 mole % siloxane, a Mw of about 23,000 Daltons (polystyrene basis). Another non-limiting example of a polycarbonate-siloxane copolymer includes opaque EXL, available from SABIC Innovative Plastics. The opaque EXL from SABIC is a polycarbonate-polysiloxane (9030P) copolymer, having been tested commercially and found to have about 20 mole % siloxane, a Mw of about 29,900 Daltons (polystyrene basis).

The polysiloxane polycarbonate copolymer component can be present in the thermoplastic composition in any desired amount. For example, in aspects of the disclosure, the polysiloxane polycarbonate copolymer is present in an amount of about 0 wt % to about 30 wt % of a polycarbonate-polysiloxane copolymer component relative to the total weight of the thermoplastic composition. In various further aspects, the polysiloxane polycarbonate copolymer is present in an amount of at least about 1 wt % relative to the total weight of the thermoplastic composition. For example, the polycarbonate-polysiloxane copolymer can be present in an amount in the range of from 1 wt % to 30 wt % relative to the total weight of the thermoplastic composition, including exemplary amounts of 0.1 wt %, 0.25 wt %, 0.5 wt %, 1.0 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, and 30 wt %. In still further aspects, the polysiloxane polycarbonate copolymer can be present within any range of amounts derived from any two of the above stated values. For example, the polysiloxane polycarbonate copolymer can be present in an amount in the range of from about 1 to about 5 wt %, or in an amount in the range of from about 1 wt % to about 10 wt %.

In one aspect, the polycarbonate-polysiloxane copolymer component is a polycarbonate-polydimethylsiloxane copolymer. In another aspect, the polycarbonate portion of the polycarbonate-polysiloxane copolymer comprises residues derived from BPA. In still another aspect, the polycarbonate portion of the polycarbonate-polysiloxane copolymer comprising residues derived from BPA is a homopolymer. In still another aspect, the polycarbonate-polysiloxane copolymer component comprises a polycarbonate-polysiloxane block copolymer.

In one aspect, the polycarbonate-polysiloxane block copolymer comprises a polycarbonate-polydimethylsiloxane block copolymer. In another aspect, the polycarbonate block comprises residues derived from BPA. In still other aspect, the polycarbonate block comprising residues derived from BPA is a homopolymer.

In one aspect, the polycarbonate-polysiloxane block copolymer comprises from about 3 wt % to about 10 wt % siloxane. In another aspect, the polycarbonate-polysiloxane block copolymer comprises from about 4 wt % to about 8 wt % siloxane. In still another aspect, the polycarbonate-polysiloxane block copolymer comprises about 5 wt % siloxane. In still another aspect, the polycarbonate-polysiloxane block copolymer comprises about 6 wt % siloxane. In still another aspect, the polycarbonate-polysiloxane block copolymer comprises about 7 wt % siloxane. In still another aspect, the polycarbonate-polysiloxane block copolymer comprises about 8 wt % siloxane.

In one aspect, the PC-Si copolymer has a weight average molecular weight from about 20,000 to about 26,000 Daltons (polystyrene basis). In another aspect, the PC-Si block copolymer has a weight average molecular weight from about 21,000 to about 25,000 Daltons. In still another aspect, the PC-Si block copolymer has a weight average molecular weight from about 22,000 to about 24,000 Daltons (polystyrene basis). In still another aspect, the PC-Si block copolymer has a weight average molecular weight of about 22,000 Daltons (polystyrene basis). In still another aspect, the PC-Si block copolymer has a weight average molecular weight of about 23,000 Daltons (polystyrene basis). In still another aspect, the PC-Si block copolymer has a weight average molecular weight of about 24,000 Daltons (polystyrene basis). In still another aspect, the PC-Si block copolymer has a weight average molecular weight of about 25,000 Daltons (polystyrene basis).

In one aspect, the polycarbonate-polysiloxane block copolymer comprises from about 1 wt % to about 25 wt % siloxane. In another aspect, the polycarbonate-polysiloxane block copolymer comprises from about 11 wt % to about 23 wt % siloxane. In still another aspect, the polycarbonate-polysiloxane block copolymer comprises from about 18 wt % to about 22 wt % siloxane. In still another aspect, the polycarbonate-polysiloxane block copolymer comprises from about 19 wt % to about 21 wt % siloxane. In still another aspect, the polycarbonate-polysiloxane block copolymer comprises about 18 wt % siloxane. In still another aspect, the polycarbonate-polysiloxane block copolymer comprises about 19 wt % siloxane. In still another aspect, the polycarbonate-polysiloxane block copolymer comprises about 20 wt % siloxane. In still another aspect, the polycarbonate-polysiloxane block copolymer comprises about 21 wt % siloxane. In still another aspect, the polycarbonate-polysiloxane block copolymer comprises about 22 wt % siloxane.

In one aspect, the polysiloxane block has a weight average molecular weight from about 25,000 to about 32,000 Daltons (polystyrene basis). In another aspect, the polysiloxane block has a weight average molecular weight from about 26,000 to about 31,000 Daltons (polystyrene basis). In still another aspect, the polysiloxane block has a weight average molecular weight from about 27,000 to about 30,000 Daltons (polystyrene basis). In still another aspect, the polysiloxane block has a weight average molecular weight from about 28,000 to about 30,000 Daltons (polystyrene basis). In still another aspect, the polysiloxane block has a weight average molecular weight of about 27,000 Daltons (polystyrene basis). In still another aspect, the polysiloxane block has a weight average molecular weight of about 28,000 Daltons. In still another aspect, the polysiloxane block has a weight average molecular weight of about 29,000 Daltons (polystyrene basis). In still another aspect, the polysiloxane block has a weight average molecular weight of about 30,000 Daltons (polystyrene basis). In still another aspect, the polysiloxane block has a weight average molecular weight of about 31,000 Daltons (polystyrene basis).

Further disclosure regarding polycarbonates and polysiloxanes may be found in published United States patent applications US 2014/0357781 and US 2014/0200303, both of which are incorporated herein by reference in their entireties for any and all purposes.

Polyesters

Cycloaliphatic polyesters can also be used and are generally prepared by reaction of organic polymer precursors such as a diol with a dibasic acid or derivative. The diols useful in the preparation of the cycloaliphatic polyester polymers are straight chain, branched, or cycloaliphatic, preferably straight chain or branched alkane diols, and can contain from 2 to 12 carbon atoms.

One or more fillers may be used, e.g., graphite, TiO2, ZnS, or BN. producers provide expanded/exfoliated graphite, like Timcal TIMREX C-THERM™, SGL Carbon Ecophit G™, which can show higher thermal conductivity performance compared to conventional flake like graphite. A challenge with these materials, however, is compounding, as the expanded/exfoliated graphite is difficult to feed into extruders due to the material's low bulk density (e.g., 0.14˜0.15 g/cc) compared to conventional graphite density of over 0.5 g/cc.

In addition to the thermoplastic polymer resin and fillers, the compositions of the present invention can include various additives ordinarily incorporated in resin compositions of this type. Mixtures of additives can be used. Such additives can be mixed at a suitable time during the mixing of the components for forming the composition. The one or more additives are included in the thermoplastic compositions to impart one or more selected characteristics to the thermoplastic compositions and any molded article made therefrom. Examples of additives that can be included in the present invention include, but are not limited to, heat stabilizers, process stabilizers, antioxidants, light stabilizers, plasticizers, antistatic agents, mold releasing agents, UV absorbers, lubricants, pigments, dyes, colorants, flow promoters, flame retardants, or a combination of one or more of the foregoing additives.

Suitable heat stabilizers include, for example, organo phosphites such as triphenyl phosphite, tris-(2,6-dimethylphenyl)phosphite, tris-(mixed mono-and di-nonylphenyl)phosphite or the like; phosphonates such as dimethylbenzene phosphonate or the like, phosphates such as trimethyl phosphate, or the like, or combinations including at least one of the foregoing heat stabilizers. Heat stabilizers are generally used in amounts of from 0.01 to 0.5 parts by weight based on 100 parts by weight of the total composition, excluding any filler.

Suitable antioxidants include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of from 0.01 to 0.5 parts by weight, based on 100 parts by weight of the total composition, excluding any filler.

Suitable light stabilizers include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of from 0.1 to 1.0 parts by weight, based on 100 parts by weight of the total composition, excluding any filler.

Suitable plasticizers include, for example, phthalic acid esters such as dioctyl-4,5-epoxy-hexahydrophthalate, tris-(octoxycarbonylethyl)isocyanurate, tristearin, epoxidized soybean oil or the like, or combinations including at least one of the foregoing plasticizers. Plasticizers are generally used in amounts of from 0.5 to 3.0 parts by weight, based on 100 parts by weight of the total composition, excluding any filler.

Suitable antistatic agents include, for example, glycerol monostearate, sodium stearyl sulfonate, sodium dodecylbenzenesulfonate, polyether block amides, which are commercially available from, for example, BASF under the Tradename Irgastat; from Arkema under the Tradename PEBAX; and from Sanyo Chemical industries under the tradename Pelestat, or combinations of the foregoing antistatic agents. In one embodiment, carbon fibers, carbon nanofibers, carbon nanotubes, carbon black, or any combination of the foregoing can be used in a polymeric resin containing chemical antistatic agents to render the composition electrostatically dissipative.

Suitable mold releasing agents include for example, metal stearate, stearyl stearate, pentaerythritol tetrastearate, beeswax, montan wax, paraffin wax, or the like, or combinations including at least one of the foregoing mold release agents. Mold releasing agents are generally used in amounts of from 0.1 to 1.0 parts by weight, (e.g., 0.1, 0.2, 0.3, 0.4, 0.5, 0.6, 0.7, 0.8, or even 0.9 parts by weight) based on 100 parts by weight of the total composition, excluding any filler.

Suitable UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenyl-acryloyl)oxy]methyl]propane (UVINUL™ 3030); 2,2′-(1,4-phenylene) bis(4H-3,1-benzoxazin-4-one); 1,3-bis[(2-cyano-3,3-diphenylacryloyl)oxyl]-2,2-bis[[(2-cyano-3,3-diphenyl-acryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from 0.01 to 3.0 parts by weight, based on 100 parts by weight based on 100 parts by weight of the total composition, excluding any filler.

Suitable lubricants include for example, fatty acid esters such as alkyl stearyl esters, e.g., methyl stearate or the like; mixtures of methyl stearate and hydrophilic and hydrophobic surfactants including polyethylene glycol polymers, polypropylene glycol polymers, and copolymers thereof e.g., methyl stearate and polyethylene-polypropylene glycol copolymers in a suitable solvent; or combinations including at least one of the foregoing lubricants. Lubricants are generally used in amounts of from 0.1 to 5 parts by weight, based on 100 parts by weight of the total composition, excluding any filler.

Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates; sulfates and chromates; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations including at least one of the foregoing pigments. Pigments are generally used in amounts of from 1 to 10 parts by weight, based on 100 parts by weight based on 100 parts by weight of the total composition, excluding any filler.

Suitable dyes include, for example, organic dyes such as coumarin 460 (blue), coumarin 6 (green), nile red or the like; lanthanide complexes; hydrocarbon and substituted hydrocarbon dyes; polycyclic aromatic hydrocarbons; scintillation dyes (preferably oxazoles and oxadiazoles); aryl- or heteroaryl-substituted poly (2-8 olefins); carbocyanine dyes; phthalocyanine dyes and pigments; oxazine dyes; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluorophores such as anti-stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 3-(2′-benzimidazolyl)-7-N,N-diethylaminocoumarin; 3-(2′-benzothiazolyl)-7-diethylaminocoumarin; 2-(4-biphenylyl)-5-(4-t-butylphenyl)-1,3,4-oxadiazole; 2-(4-biphenyl)-6-phenylbenzoxazole-1,3; 2,5-Bis-(4-biphenylyl)-1,3,4-oxadiazole; 2,5-bis-(4-biphenylyl)-oxazole; 4,4′-bis-(2-butyloctyloxy)-p-quaterphenyl; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-diethylamino-4-methylcoumarin; 7-diethylamino-4-trifluoromethylcoumarin; 2,2′-dimethyl-p-quaterphenyl; 2,2-dimethyl-p-terphenyl; 7-ethylamino-6-methyl-4-trifluoromethylcoumarin; 7-ethylamino-4-trifluoromethylcoumarin; nile red; rhodamine 700; oxazine 750; rhodamine 800; IR 125; IR 144; IR 140; IR 132; IR 26; IRS; diphenylhexatriene; diphenylbutadiene; tetraphenylbutadiene; naphthalene; anthracene; 9,10-diphenylanthracene; pyrene; chrysene; rubrene; coronene; phenanthrene or the like, or combinations including at least one of the foregoing dyes. Dyes are generally used in amounts of from 0.1 to 5 parts by weight, based on 100 parts by weight of the total composition, excluding any filler.

Suitable colorants include, for example titanium dioxide, anthraquinones, perylenes, perinones, indanthrones, quinacridones, xanthenes, oxazines, oxazolines, thioxanthenes, indigoids, thioindigoids, naphthalimides, cyanines, xanthenes, methines, lactones, coumarins, bis-benzoxazolylthiophene (BBOT), napthalenetetracarboxylic derivatives, monoazo and disazo pigments, triarylmethanes, aminoketones, bis(styryl)biphenyl derivatives, and the like, as well as combinations including at least one of the foregoing colorants. Colorants are generally used in amounts of from 0.1 to 5 parts by weight, based on 100 parts by weight of the total composition, excluding any filler.

Suitable blowing agents include for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′ oxybis(benzenesulfonylhydrazide), sodium bicarbonate, ammonium carbonate, or the like, or combinations including at least one of the foregoing blowing agents. Blowing agents are generally used in amounts of from 1 to 20 parts by weight, based on 100 parts by weight of the total composition, excluding any filler.

Additionally, materials to improve flow and other properties can be added to the composition, such as low molecular weight hydrocarbon resins or dendritic polyols (such as Boltorn from Perstop) or dendritic polyesteramides (such as Hybrane from DSM). Particularly useful classes of low molecular weight hydrocarbon resins are those derived from petroleum C5 to C9 feedstock that are derived from unsaturated C5 to C9 monomers obtained from petroleum cracking. Non-limiting examples include olefins, e.g. pentenes, hexenes, heptenes and the like; diolefins, e.g. pentadienes, hexadienes and the like; cyclic olefins and diolefins, e.g. cyclopentene, cyclopentadiene, cyclohexene, cyclohexadiene, methyl cyclopentadiene and the like; cyclic diolefin dienes, e.g., dicyclopentadiene, methylcyclopentadiene dimer and the like; and aromatic hydrocarbons, e.g. vinyltoluenes, indenes, methylindenes and the like. The resins can additionally be partially or fully hydrogenated.

Examples of flame retardants include, but are not limited to, halogenated flame retardants, like tretabromo bisphenol A oligomers such as BC58 and BC52, brominated polystyrene or poly(dibromo-styrene), brominated epoxies, decabromodiphenyleneoxide, pentabrombenzyl acrylate monomer, pentabromobenzyl acrylate polymer, ethylene-bis(tetrabromophthalimide, bis(pentabromobenzyl)ethane, metal hydroxides like Mg(OH)₂ and Al(OH)₃, melamine cyanurate, phosphor based FR systems like red phosphorus, melamine polyphosphate, phosphate esters, metal phosphinates, ammonium polyphosphates, expandable graphites, sodium or potassium perfluorobutane sulfate, sodium or potassium perfluorooctane sulfate, sodium or potassium diphenylsulfone sulfonate and sodium- or potassium-2,4,6-trichlorobenzoate and N-(p-tolylsulfonyl)-p-toluenesulfimide potassium salt, N—-(N′-benzylaminocarbonyl)sulfanylimide potassium salt, or a combination containing at least one of the foregoing. Fillers and additives can be added in amounts ranging from about 0.1 to about 40% or even about 50% by weight percent of the total composition.

Illustrative Embodiments

Due to the conversion of part of the blue LED light by the phosphor to create a white spectrum, the intensity of the blue and long wavelength UV phonons will decrease. Therefore, most of the accelerated testing to check the performance of a material for white LEDs is done by exposure to straight Blue-LED light. Surprisingly it has now been discovered that polymers based on micro-cellular foamed structures show a far better aging performance under white/blue-LED light compared to high-reflective polymer compositions based on high-refractive fillers.

Foamed micro-cellular polycarbonate and polyesters materials are known and marketed as sheet materials by Furukawa and Toray. Although these materials will probably also have a good white/blue-LED aging performance, so far this aspect has to my knowledge not been reported in patent or open literature.

Although sheets are of interest, most of our reflective materials are used for injection molding, allowing more design freedom in the final part than using a foamed sheet and laminating it to a load-bearing structure. Typically we have combined the MuCell Technology to create the micro-cellular structure in the injection molded process, resulting in injection molded products showing the improved aging performance under blue/white LED exposure.

Foamed, micro-cellular structures can improve the reflectivity significantly. Cell-size is important and in general the smaller the cell size, the higher the reflectivity. The foamed/micro-cellular structures were obtained by injection molding PC on an injection molding machine equipped with MuCell technology and heat-and-cool technology. Nitrogen was used as “foaming” gas. The Mucell unit inject at high pressure (350 bar), nitrogen into the molten PC which is injected into a heated mold. During the filling of the mold, a gas counter pressure might be used to prevent desaturation of nitrogen in the PC-melt. Typically, after a certain hold time, the mold is allowed to expand to a certain thickness and allowed to cool down before being ejected. Typically the cell size can be influenced with mold temperature, holding time and whether or not gas counter pressure is used. Use of gas counter pressure (GCP) gives in general smaller cell size as without GCP. Increasing the holding time results in a better homogeneous material temperature and a more homogeneous cell size. With respect to mold temperature there is an optimum depending on the material and viscosity of the material used. Without being bound to any particular theory, for high-MW PC a mold temperature of 165° C. gives optimum results, with the higher temperatures resulting in larger cells sizes and hence lower reflectivity.

Reflectivity was measured on an XRite Color I7™ with Color IQC9™ software and a 6 mm aperture.

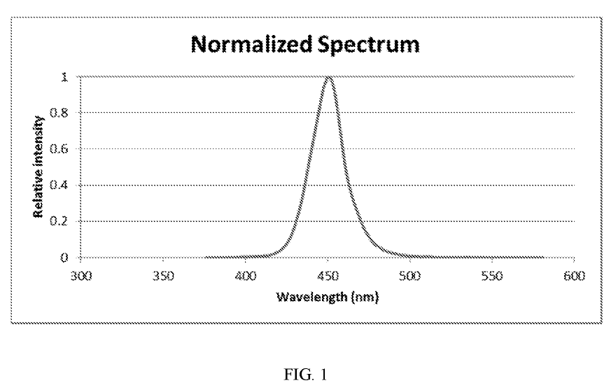

Accelerated LED aging was performed on an ETIC-082™ (ETIC=Elevated Temperature Irradiance Chamber) machine from Orb Optronix CSA equipped with Blue LEDs emitting the spectrum as displayed in FIG. 1.

The ETIC was coupled to a Thermoflex Cool unit (Neslab Thermoflex 3500™) from Fisher Scientific. This set-up allowed study of the combined effects of high intensity blue LED radiation and heat.

Within each apparatus there were 8 stations/sample holders, each with its own Blue LED, which can independently be operated. The samples were exposed to the following conditions over a series of (unequal) intervals until failure: Irradiance: 35 kW/m², Temperature: 90° C.

If the temperature of the samples deviated by more than 2° C. or 2% of the set oven-temperature the irradiation of that specific sample was stopped. Visual inspection, after cooling, showed that in all cases, the samples were significantly yellowed (YI>15) or even charred or burned. Further exposure of the yellowed samples led to catastrophic failure (completely charred or a hole burned through) within the next 0.5-4 hours in some instances.

A sample was designated as being failed if visually a yellowing or charring is observed. For the majority of the tests, the failed samples remained in their station in the oven but were no longer irradiated. At the end of each interval, the samples were allowed to cool and visually inspected. If yellowing and/or charring was observed, the sample was designated as being failed and the corresponding real irradiation time was monitored. In addition, the degree of Yellowness index (YI), was then measured using a spectrophotometer for the non-failed samples.

Table 1 gives an overview of the composition of the starting materials being used. It has been mentioned in literature that addition of so-called nucleants can improve the homogeneity of the cell structures being formed. PC2 contains fumed silica, a so-called heterogeneous nucleant. The compounding conditions used to produce the PC1 and PC2 materials are listed in Table 2.

PC1 and PC2 materials were converted into injection molded foamed-microcellular structures using the set-up (an injection molding machine with Mucell and heat-and-cool technology) as described above and under the conditions presented in Table 3. Sample designation, foaming conditions (if applicable) and reflectivity for the samples of the invention and comparative samples, PC based on highly-loaded TiO₂ (Lexan™ LUX1619-WH9G012 and Lexan LUX 2619-WH9G012), are displayed in this table. The molding conditions for the Lexan™ LUX comparative materials are listed in Table 4).

TABLE 1
Composition of the samples used for microcellular molding

Composition (wt %)

| Material coded as | PC-1 | PC-2 |
|---|---|---|
| PC135 | 99.95 | 99.45 |
| stab. % | 0.05 | 0.05 |
| Fumed Silica % | | 0.5 |

TABLE 2
Compounding conditions PC1 and PC2 materials

| Parameters | UOM | Default Values |
|---|---|---|
| Profile D | None | Lexan 5 |
| Feed (Zone 0) Temp | ° C. | 40 |
| Zone 1 Temp | ° C. | 200 |
| Zone 2 Temp | ° C. | 250 |
| Zone 3 Temp | ° C. | 270 |
| Zone 4 Temp | ° C. | 310 |
| Zone 5 Temp | ° C. | 310 |
| Zone 6 Temp | ° C. | 310 |
| Zone 7 Temp | ° C. | 310 |
| Zone 8 Temp | ° C. | 310 |
| Die Temp | ° C. | 310 |
| Screw speed | rpm | 300 |
| Throughout | kg/hr | |
| Torque | % | As high as possible |
| Vacuum1 | Bar | 0.7 |

TABLE 3
Microcellular foaming conditions and reflectivity

| | | | Foaming conditions | | | | | |
|---|---|---|---|---|---|---|---|---|
| | | | Mold-Temp | Delay | | Density | Reflectivity (%) | |
| Sample | Material | Nucleant | (° C.) | (s) | GCP | (g/cm³) | 380-420 nm | 400-700 nm |
| 1 | PC1 | none | 180 | 6 s | yes | 0.437 | 88.2 | 93.4 |
| 2 | PC2 | 0.5% Silica | 165 | 6 s | yes | 0.427 | 90.7 | 94.9 |

| | | | | |
|---|---|---|---|---|
| C1 | LEXAN LUX1619-WH9G012 | 1.340 | 50.4 | 93.3 |
| C2 | LEXAN LUX2619-WH9G012 | 1.340 | 50.9 | 94.2 |

TABLE 4
Molding conditions comparative materials

| | | LEXAN | LEXAN |
|---|---|---|---|
| | | LUX1619- | LUX2619- |
| | | WH9G012 | WH9G012 |
| Drying Time | (hrs) | 2 | 2 |
| Drying temperature | (° C.) | 120 | 120 |
| T hopper | (° C.) | 40 | 40 |
| T zone 1 | (° C.) | 280 | 280 |
| T zone 2 | (° C.) | 285 | 285 |
| T zone 3 | (° C.) | 295 | 295 |
| T nozzle | (° C.) | 290 | 290 |
| T mold | (° C.) | 110 | 110 |

Table 3 shows that the materials tested all have well to excellent reflectivity in the visible range (400-700nm). SEM investigations confirmed the micro-cellular structures in the PC1 and PC2 materials, with cell sizes typically less than about 20 micron.

Although the reflectivity is in the same range, there is a remarkable difference in the time-to-failure in the accelerated Blue-LED aging test (see Table 5 below). Whereas the average time-to-failure for the PC materials based on high-refractive white fillers (sample C1 and C2) is less than 100 hours, microcellular PC materials (samples 1 and 2) lasted at least 4 times longer reaching 379 (sample 2) and 463 hours (sample 1), respectively.

TABLE 5
Time-to-failure in Blue-LED aging

Blue-LED aging

| | | |
|---|---|---|
| | hrs-to-failure | |
| | (individual | hrs-to-failure |
| Sample | samples) | (averaged) |

| | | | |
|---|---|---|---|
| 1 | A | 464 | 463 |
| | B | 461 | |
| 2 | A | 388 | 379 |
| | B | 369 | |
| C1 | A | 75 | 84 |
| | B | 93 | |
| C2 | A | 75 | 93 |
| | B | 111 | |

As explained herein, foamed, micro-cellular structures exhibit improved reflectivity in certain wavelengths, e.g., the 315-400 nm range. Without being bound to any particular theory, in general the smaller the cell size, the higher the reflectivity.

Exemplary foamed/micro-cellular structures may be obtained by injection molding PC on an injection molding machine equipped with a cell-forming technology (e.g., MuCell™ technology) and heat and cool capability. For the examples given herein, nitrogen was be used as “foaming” gas, although other gases will be known to those of skill in the art.

For these exemplary materials, a MuCell unit injected nitrogen at high pressure (350 bar) into molten polycarbonate (PC) (having a weight-average molecular weight, on a polystyrene basis, of about 70 kDaltons) that was injected into a heated mold. During the filling of the mold, gas counter pressure may be used to prevent desaturation of nitrogen in the PC-melt. After a hold time, the mold is allowed to expand to a certain thickness and allowed to cool down before being ejected. Without being bound to any particular theory, cell size may be influenced with mold temperature, holding time and by whether or not gas counter pressure is used.

Again without being bound to any particular theory, the use of gas counter pressure (GCP) gives in general smaller cell size as without GCP. Increasing the holding time results in a more homogeneous material temperature and a more homogeneous cell size. For high molecular weight PC, a mold temperature of 165° C. provided favorable results; higher temperatures result in larger cells sizes and hence lower reflectivity. For the examples provided herein, reflectivity was measured on a Perkin Elmer Lambda 950 spectrophotometer with a 150 mm reflective sphere, Spectralon coated.

Table 6 below provides the composition of the starting materials being used. PC 2 and PC3 contain a so-called heterogeneous nucleant (talc and silica, in this case) whereas in PC4 uses a siloxane block in the PC-siloxane copolymer as a homogeneous nucleant.

TABLE 6
Composition formulations for microcellular molding

| | Material coded as | | | |
|---|---|---|---|---|
| | PC-1 | PC-2 | PC-3 | PC-4 |
| PC % | 99.95 | 99.45 | 99.45 | 24.95 |
| EXL-T % | | | | 75 |
| stab. % | 0.05 | 0.05 | 0.05 | 0.05 |
| Fumed Silica % | | 0.5 | | |
| Fine Talc % | | | 0.5 | |

Molding parameters

| | | | | |
|---|---|---|---|---|
| Pre drying temp ° C. | 120 | 120 | 120 | 120 |
| Pre-drying time hrs | 3-4 | 3-4 | 3-4 | 3-4 |
| max. Moisture content % | 0.02 | 0.02 | 0.02 | 0.02 |
| Melt temp. ° | 320-345 | 320-345 | 320-345 | 320-345 |
| Nozzle temp ° C. | 315-340 | 315-340 | 315-340 | 315-340 |
| Front barrel ° C. | 320-345 | 320-345 | 320-345 | 320-345 |
| Middle barrel ° C. | 310-330 | 310-330 | 310-330 | 310-330 |
| End barrel ° C. | 300-320 | 300-320 | 300-320 | 300-320 |

These materials were converted into injection molded foamed-microcellular structures using the set-up (injection molding machine with MuCell and heat and cool technology) as described above.

The following aspects are illustrative only and do not serve to limit the scope of the present disclosure or the claims appended hereto.

Aspect 1. An article, comprising: a region having a cellular structure comprising a plurality of cells, the plurality of cells having a number-average cross-sectional dimension in the range of from about 0.3 micrometers up to about 100 micrometers (e.g., from about 0.5 to about 95, from about 1 to about 90, from about 2 to about 85, from about 3 to about 80, from about 4 to about 75, from about 5 to about 70, from about 6 to about 65, from about 7 to about 60, from about 8 to about 55, from about 9 to about 50, from about 10 to about 45, from about 11 to about 40, from about 12 to about 35, from about 13 to about 30, from about 14 to about 25, from about 15 to about 20, or even about 17 micrometers), and the article having a YI of less than 15 (e.g., a YI about 14, 13, 12, 11, 10, 9, 8, 7, 6, 5, 4, 3, 2, or even about 1) upon exposure for 100 hours to 35 kW/m² illumination having a peak centered at about 450 nm.

The plurality of cells may have a number-average cross-sectional dimension in the range of from about 1 micrometer up to about 80 micrometers, or from about 5 micrometers up to about 40 micrometers, or even from about 10 micrometers up to about 15 micrometers. Cells having a number-average cross-sectional dimension in the range of less than 40 micrometers are especially suitable, in particular cells having a number-average cross-sectional dimension of less than 10 micrometers, e.g. from about 1 to about 10 micrometers.

For purposes of this disclosure, YI is determined according to ASTM D1925-95 CIE illuminant C and 2 degree observer on a X-Rite i7™ spectrophotometer using an integrating sphere with 8°/diffuse geometry, specular component included, UV included, a 6 mm small area view lens, and a 25 mm large area view transmission port.

Aspect 2. The article of aspect 1, wherein the article has a YI according of less than 15 (e.g., 14, 13, 12, 11, 10, 9, 8, 7, 6, 5, 4, 3, 2, or 1) upon exposure for 200 hours to 35 kW/m² illumination having a peak centered at about 450 nm.

Aspect 3. The article of aspect 2, wherein the article has a YI according of less than 15 (e.g., 14, 13, 12, 11, 10, 9, 8, 7, 6, 5, 4, 3, 2, or 1) upon exposure for 300 hours to 35 kW/m² illumination having a peak centered at about 450 nm.

Aspect 4. The article of aspect 3, wherein the article has a YI of less than 15 (e.g., 14, 13, 12, 11, 10, 9, 8, 7, 6, 5, 4, 3, 2, or 1) upon exposure for 400 hours to 35 kW/m² illumination having a peak centered at about 450 nm.

Aspect 5. The article of any of aspects 1-4, wherein the region has a reflectivity of at least about 80% (e.g., about 80%, 85%, 90%, 95%, or greater) for illumination in the range of from about 380 nm to about 420 nm and of at least about 80% (e.g., about 80%, 85%, 90%, 95%, or greater) for illumination in the range of from about 400 to about 700 nm,

Aspect 6. The article of any of aspects 1-5, wherein the article is characterized as injection-molded.

Aspect 7. The article of any of aspects 1-6, wherein the region comprises an amount of phosphor. Without limitation, a variety of phosphor species may be incorporated into substrates (e.g., plastic substrates) to fluorescence (emit white light) when irradiated with blue light emitting LEDs thus providing white light. Exemplary phosphor species include, e.g., strontium based, ZnS based, calcium based, barium based, YAG, pigment based, aluminate based (GAL), europium based, silicate based, nitride based, luminova, sulphate based, TAG, vanadates, oxazole based, silicates, NYAG (Garnet) phosphors, red nitride phosphors, and any combination thereof

One benefit of using a remote phosphor (i.e. phosphor attached to a substrate that is remote from a blue LED light source) is that white light can be achieved with no visible point sources. This in turn ensures a low glare system and can improve efficiency and overall system life/reliability and leads to less color shift over time.

Aspect 8. The article of aspect 7, wherein at least some of the phosphor resides on a surface of the article.

Aspect 9. The article of any of aspects 1-8, wherein the region comprises plastic, metal, glass, carbon, or any combination thereof

Aspect 10. The article of aspect 9, wherein the plastic comprises a thermoplastic. Suitable thermoplastics include, e.g., polycarbonate, polyester, or any combination thereof. Although polycarbonate is an especially suitable thermoplastic, other thermoplastics (polyesters, PET, polyamides, PBT) are also suitable, and one of ordinary skill in the art will encounter no difficulty in identifying thermoplastics. Mixtures of two, three, or more thermoplastics are considered suitable.

In some embodiments, the thermoplastic comprises a polycarbonate having a weight-average molecular weight (polystyrene basis) of from about 10 to about 100 (e.g., 15, 20, 25, 30, 35, 40, 45, 50, 55, 60, 65, 70, 75, 80, 85, 90, or even 95) kDaltons (polystyrene basis). Suitable weight-average molecular weights may also be from about 15 to about 95, from about 20 to about 90, from about 25 to about 85, from about 25 to about 80, from about 30 to about 70, from about 40 to about 50, or even about 50 kDaltons (polystyrene basis). The thermoplastic may comprise a polycarbonate having a weight-average molecular weight (polystyrene basis) of from about 40 to about 50 kDaltons (polystyrene basis).

Aspect 11. The article of aspect 9, wherein the plastic comprises a thermoset.

Aspect 12. The article of aspect 1, wherein the region comprises a nucleant.

Aspect 13. The article of aspect 12, wherein the nucleant comprises talc, silica, siloxane, clay, or any combination thereof

Aspect 14. The article of aspect 13, wherein the nucleant comprises siloxane.

Aspect 15. The article of aspect 14, wherein the siloxane is included in a copolymer. PC-Polysiloxane polymers are described elsewhere herein, and include block, branched, and all other forms of copolymers.

Aspect 16. The article of aspect 14, wherein the siloxane is admixed with a plastic. The siloxane may have an average block length of from about 20 to about 100.

Aspect 17. The article of any of aspects 1-16, wherein the plurality of cells has a spatial density in the range of from 10³ cells/cm³ to 10¹⁵ cells/cm³, e.g., from about 10⁶ to about 10⁹ cells/cm³.

Aspect 18. The article of any of aspects 1-16, wherein the plurality of cells represents from about 5 to about 70 vol % of the region. In some embodiments, cells are sized and dispersed such that they reduce the density of the matrix (as compared to a cell-free matrix) by from 10% to 90%, and all intermediate values. Reducing the density by 60% is considered especially suitable. The microcellular materials may have a density of from about 5% to about 99% of the base thermoplastic (uncelled) material, e.g., 40% of the uncelled material.

Aspect 19. The article of any of aspects 1-18, wherein at least 50% of the plurality of cells, by number, are characterized as closed cells. Pluralities of cells that are from 70-95% (by number) closed cells are considered especially suitable.

As is known in the art, cells in foam are bubbles that have been frozen in size and shape after solidification of a polymer melt. Two types of cells are open and closed cells.

In closed cell foams, each cell is an independent, closed entity. The walls of gas bubbles have no holes in them. The cell will contain gas if the polymer is impermeable to gas used for foaming.

So-called “open” cells are interconnected and are thus unable to hold gas. They are broken and air fills the open space inside material. This makes foam weaker or softer. The advantages of closed-cell foam compared to open-cell foam include its strength, higher R-value, and its greater resistance to the leakage of air or water vapor.

Aspect 20. The article of any of aspects 1-19, wherein at least 20% of the plurality of cells, by number, are characterized as having as aspect ratio of between about 1 and about 5. (e.g, spherical cells). In an article, up to 30%, 40%, 50%, 60%, 70%, 80%, 90% or even all of the cells may be characterized as spherical. In some embodiments, at least 50% of the plurality of cells, by number, are characterized having an aspect ratio of between about 1 and about 5. In an article, up to 30%, 40%, 50%, 60%, 70%, 80%, 90% or even all of the cells may be characterized as having as aspect ratio of between about 1 and about 5.

Aspect 21. The article of any of aspects 1-20, wherein upon exposure for 100 hours to 35 kW/m² illumination having a peak centered at about 450 nm in a chamber kept at about 90 deg. C., the article has a YI of less than 15 (e.g., 14, 13, 12, 11, 10, 9, 8, 7, 6, 5, 4, 3, 2, 1).

Aspect 22. The article of any of aspects 1-21, wherein the thermoplastic region is substantially free of swirl marks.

Aspect 23. The article of any of aspects 1-22, wherein the article is in optical communication with a blue LED characterized by an intensity peak centered at about 450 nm.

Aspect 24. The article of aspect 23, wherein the article is characterized as an overhead illuminator, a reflector lamp, a back reflector (in edge lit panels), a flat reflector, a thermoformed reflector, or any combination thereof. Articles may be used in signboards, lighting fixtures, and the like. Suitable articles include also reflectors, housings, collars, and the like. It should be understood that an article may be a film or a sheet in configuration. An article may have an entire through-thickness that has the disclosed characteristics (e.g., a sheet, the entire sheet having the disclosed characteristics). Alternatively, an article may include a region (e.g., a 1 mm thick surface layer that is part of a thicker overall article) that has the disclosed characteristics. The disclosed cellular thermoplastics may even be applied as a layer (e.g., via adhesive, bonding, heat-sealing, or other attachment methods) to an existing article, e.g., a reflector already in service. An article may include a microcellular region (e.g., at the surface) and a region that does not include a cellular structure.

It should also be understood that the disclosed articles may include an additive. Suitable additives are described elsewhere herein.

Aspect 25. A method, comprising: illuminating, with a source of illumination having a peak in the range of from about 440 to about 500 nm, an article comprising a region having a cellular structure comprising a plurality of cells, the plurality of cells having a number-average cross-sectional dimension in the range of from about 0.3 micrometers up to about 100 micrometers, and the article having a YI of less than 15 (e.g., 14, 13, 12, 11, 10, 9, 8, 7, 6, 5, 4, 3, 2, 1) upon exposure for 100 hours to 35 kW/m² illumination having a peak centered at about 450 nm. Articles according to any of aspects 1-24 are also considered suitable.

Aspect 26. The method of aspect 25, wherein the article has a YI according of less than 15 (e.g., 14, 13, 12, 11, 10, 9, 8, 7, 6, 5, 4, 3, 2, 1) upon exposure for 200 hours to 35 kW/m² illumination having a peak centered at about 450 nm.

Aspect 27. The method of aspect 26, wherein the article has a YI according of less than 15 (e.g., 14, 13, 12, 11, 10, 9, 8, 7, 6, 5, 4, 3, 2, 1) upon exposure for 300 hours to 35 kW/m² illumination having a peak centered at about 450 nm.

Aspect 28. The method of aspect 27, wherein the article has a YI of less than 15 (e.g., 14, 13, 12, 11, 10, 9, 8, 7, 6, 5, 4, 3, 2, 1) upon exposure for 400 hours to 35 kW/m² illumination having a peak centered at about 450 nm.

Aspect 29. The method of any of aspects 25-28, wherein the region has a reflectivity of at least about 80% for illumination in the range of from about 380 nm to about 420 nm and of at least about 80% for illumination in the range of from about 400 to about 700 nm,

Aspect 30. The method of any of aspects 25-29, wherein the article is characterized as injection-molded.

Aspect 31. The method of any of aspects 25-30, wherein the region comprises an amount of phosphor.

Aspect 32. The method of aspect 31, wherein the amount of phosphor comprises a silicate, a NYAG (Garnet) phosphor, a GAL (aluminate) phosphor, a red nitride phosphor, or any combination thereof

Aspect 33. The method of any of aspects 25-32, wherein at least 50% of the plurality of cells, by number, are characterized as closed cells.

Aspect 34. The method of aspect 25, wherein the source of illumination comprises a blue LED characterized by an intensity peak centered at about 450nm.

Aspect 35. The method of any of aspects 25-34, wherein the article comprises an additive. Suitable additives are described elsewhere herein, but may include, without limitation, nucleants, clay (including nanoclay materials comprising particles having a cross-sectional dimension of less than about 100 nm), rubber, TPE (thermoplastic elastomer), coupling agents, antioxidants, mold release agents, UV absorbers, light stabilizers, heat stabilizers, lubricants, plasticizers, pigments, dyes, colorants, anti-static agents, nucleating agents, anti-drip agents, acid scavengers, and combinations thereof. In a further aspect, the blend thermoplastic compositions of the present invention further comprise at least one polymer additive selected from a flame retardant, a colorant, a primary anti-oxidant, and a secondary anti-oxidant.

Aspect 36. The method of aspect 35, wherein the additive comprises ZnS, TiO2, BN, or any combination thereof

Aspect 37. A method of improving surface aging performance, comprising: in an illumination device having a surface configured to reflect illumination, replacing or covering at least some of said surface with an article comprising a region having a cellular structure comprising a plurality of cells, the plurality of cells having a number-average cross-sectional dimension in the range of from about 0.3 micrometers up to about 100 micrometers, and the article having a YI of less than 15 (e.g., 14, 13, 12, 11, 10, 9, 8, 7, 6, 5, 4, 3, 2, 1) upon exposure for 100 hours to 35 kW/m² illumination having a peak centered at about 450 nm.

A user may apply (e.g., via adhesive) an article according to the present disclosure to an existing surface so as to alter the reflectivity characteristics of that surface. This may be done, for example, to re-fit a display arrangement after an illumination source has been changed from, e.g., an incandescent source to a blue LED.

Aspect 38. The method of aspect 37, wherein the article is characterized as a film.

Aspect 39. The method of aspect 37, further comprising attaching the article to the surface.

Aspect 40. The method of aspect 38, further comprising disposing a source of illumination having a peak in the range of from about 440 to about 500 nm so as to be capable of illuminating at least a portion of the reflective article.

Aspect 41. The method of aspect 37, wherein the source of illumination comprises a blue LED characterized by an intensity peak centered at about 450 nm.

Aspect 42. The method of aspect 37, wherein the article is characterized as being injection molded.

Aspect 43. The method of aspect 37, further comprising introducing a blue LED characterized by an intensity peak centered at about 450 nm.

Aspect 44. The method of any of claim 25 or 37, wherein the article comprises an amount of phosphor.

Aspect 45. The method of aspect 44, wherein the amount of phosphor comprises a silicate, a NYAG (Garnet) phosphor, a GAL (aluminate) phosphor, a red nitride phosphor, or any combination thereof

1. An article, comprising:
a region having a cellular structure comprising a plurality of cells,
the plurality of cells having a number-average cross-sectional dimension in the range of from about 0.3 micrometers up to about 100 micrometers, and
the article having a YI of less than 15 upon exposure for 100 hours to 35 kW/m²

2. The article of claim 1, wherein the article has a YI according of less than 15 upon exposure for 200 hours to 35 kW/m² illumination having a peak centered at about 450 nm.

3. The article of claim 1, wherein the article has a YI according of less than 15 upon exposure for 300 hours to 35 kW/m² illumination having a peak centered at about 450 nm.

4. The article of claim 1, wherein the article is characterized as injection-molded.

5. The article of claim 1, wherein the region comprises an amount of phosphor.

6. The article of claim 5, wherein at least some of the phosphor resides on a surface of the article.

7. The article of claim 1, wherein the region comprises plastic, metal, glass, carbon, or any combination thereof.

8. The article of claim 7, wherein the plastic comprises a thermoplastic.

9. The article of claim 8, wherein the thermoplastic comprises polycarbonate.

10. The article of claim 9, wherein the plastic comprises a thermoset.

11. The article of claim 1, wherein the region comprises a nucleant.

12. The article of claim 11, wherein the nucleant comprises talc, silica, siloxane, clay, or any combination thereof.

13. The article of claim 12, wherein the nucleant comprises siloxane.

14. The article of claim 1, wherein the plurality of cells has a spatial density in the range of from 10³ cells/cm³ to 10¹⁵ cells/cm³.

15. The article of claim 1, wherein the plurality of cells represents from about 5 to about 70 vol % of the region.

16. The article of any claim 1, wherein at least 50% of the plurality of cells, by number, are characterized as closed cells.

17. The article of claim 1, wherein at least 20% of the plurality of cells, by number, are characterized as having as aspect ratio of between about 1 and about 5.

18. The article of claim 1, wherein the thermoplastic region is substantially free of swirl marks.

19. The article of claim 1, wherein the article is in optical communication with a blue LED characterized by an intensity peak centered at about 450 nm.

20. The article of claim 1, wherein the article is characterized as an overhead illuminator, a reflector lamp, a back reflector, or any combination thereof
